(19) United States
(12) Patent Application Publication
(10) Pub. No.: US 2009/0046598 A1
(43) Pub. Date: Feb. 19, 2009

(54) SYSTEM AND METHOD FOR ACQUIRING OR DISTRIBUTING INFORMATION RELATED TO ONE OR MORE ALTERNATE AD HOC SERVICE PROVIDERS

(75) Inventors: Dilip Krishnaswamy, San Diego, CA (US); Atul Suri, San Diego, CA (US); Mark Charlebois, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/147,240

(22) Filed: Jun. 26, 2008

Related U.S. Application Data
(60) Provisional application No. 60/956,658, filed on Aug. 17, 2007.
(60) Provisional application No. 60/980,565, filed on Oct. 17, 2007.

(51) Int. Cl. H04L 12/28

(52) U.S. Cl. 370/254

(57) ABSTRACT

An ad hoc service provider includes a processing system configured to receive information regarding a second ad hoc service provider. The information includes service information of the second ad hoc service provider. The processing system is further configured to support transmission of the information to a server. The processing system is also configured to support an access point to a network for a mobile client. A method is also provided for acquiring or distributing information related to one or more alternate ad hoc service providers.

### CLAIM OF PRIORITY UNDER 35 U.S.C. §119

The present Application for Patent claims priority to Provisional Application No. 60/956,658 entitled “METHOD FOR A HETEROGENEOUS WIRELESS AD HOC MOBILE SERVICE PROVIDER” filed Aug. 17, 2007 and Provisional Application No. 60/980,565 entitled “SYSTEM AND METHOD FOR ACQUIRING OR DISTRIBUTING INFORMATION RELATED TO ONE OR MORE ALTERNATE AD HOC SERVICE PROVIDERS” filed Oct. 17, 2007, all of which are assigned to the assignee hereof and hereby expressly incorporated by reference herein.

### BACKGROUND

1. Field

The subject technology relates generally to telecommunications, and more specifically to a system or method for acquiring or distributing information related to one or more alternate ad hoc service providers.

2. Background

Wireless telecommunication systems are widely deployed to provide various services to consumers, such as telephony, data, video, audio, messaging, broadcasts, etc. Today, wireless networks are providing broadband Internet access to mobile subscribers. Such networks are sometimes referred as Wireless Wide Area Networks (WWANs). WWAN operators generally offer wireless access plans to their subscribers.

Accessing WWANs from all mobile devices may not be possible. Some mobile devices may not have a WWAN radio. Other mobile devices with a WWAN radio may not have a subscription plan enabled. Ad hoc networking allows mobile devices to dynamically connect over wireless interfaces using protocols such as WLAN, Bluetooth, UWB, or other protocols. There is a need in the art for a methodology to allow a user of a mobile device without WWAN access to dynamically subscribe to wireless access service provided by a user with a WWAN-capable mobile device using wireless ad hoc networking between the mobile devices belonging to the two users.

### SUMMARY

In one aspect of the disclosure, an ad hoc service provider includes a processing system configured to receive information regarding a second ad hoc service provider. The information includes service information of the second ad hoc service provider. The processing system is further configured to support transmission of the information to a server. In addition, the processing system is configured to support an access point to a network for a mobile client.

In another aspect of the disclosure, an ad hoc service provider includes means for receiving information regarding a second ad hoc service provider. The information includes service information of the second ad hoc service provider. The ad hoc service provider further includes means for supporting transmission of the information to a server and means for supporting an access point to a network for a mobile client.

In a further aspect of the disclosure, a method is provided for acquiring or distributing information related to one or more alternate ad hoc service providers. The method includes receiving at an ad hoc service provider information regarding a second ad hoc service provider. The ad hoc service provider is configured to support an access point to a network for a mobile client. The information includes service information of the second ad hoc service provider. The method further includes transmitting the information to a server in the network.

In yet a further aspect of the disclosure, a machine-readable medium includes instructions executable by a processing system in a first mobile node. The instructions include code for receiving information regarding a second ad hoc service provider. The second ad hoc service provider is configured to support an access point to a network for a mobile client. The information includes service information of the second ad hoc service provider. The instructions further include code for supporting transmission of the information to a server in the network.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a simplified block diagram illustrating an example of a telecommunications system.

FIG. 2 is a simplified block diagram illustrating an example of a hardware configuration for a server.

FIG. 3 is a simplified block diagram illustrating an example of the functionality of an ad hoc service provider.

FIG. 4 is a simplified block diagram illustrating an example of a hardware configuration for an ad hoc service provider.

FIG. 5 is a simplified block diagram illustrating an example of a telecommunications system having clusters.

FIG. 6a is a flow chart illustrating an exemplary operation of acquiring ad hoc service provider topology knowledge.

FIG. 6b is a flow chart illustrating an exemplary operation of acquiring or distributing ad hoc service provider topology knowledge.

FIG. 7 is a flow chart illustrating another exemplary operation of acquiring or distributing ad hoc service provider topology knowledge.

FIG. 8 is a simplified block diagram illustrating an example of a system.

FIG. 9 is a simplified block diagram illustrating an example of the functionality of a server.

FIG. 10 is a simplified block diagram illustrating an example of the functionality of a server.

FIG. 11 is a simplified block diagram illustrating an example of the functionality of a server.

FIG. 12 is a simplified block diagram illustrating an example of the functionality of an ad hoc service provider.

FIG. 13 is a simplified block diagram illustrating an example of the functionality of a module for receiving from a first ad hoc service provider information regarding a second ad hoc service provider.

FIG. 14 is a simplified block diagram illustrating an example of the functionality of an ad hoc service provider.

FIG. 15 is a simplified block diagram illustrating an example of the functionality of an ad hoc service provider.

FIG. 16 is a simplified block diagram illustrating an example of the functionality of an ad hoc service provider.

FIG. 17 is a simplified block diagram illustrating an example of the functionality of a module for receiving information regarding a second ad hoc service provider.

### DETAILED DESCRIPTION

The detailed description set forth below in connection with the appended drawings is intended as a description of various configurations of the subject technology and is not intended to represent the only configurations in which the subject technology may be practiced. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

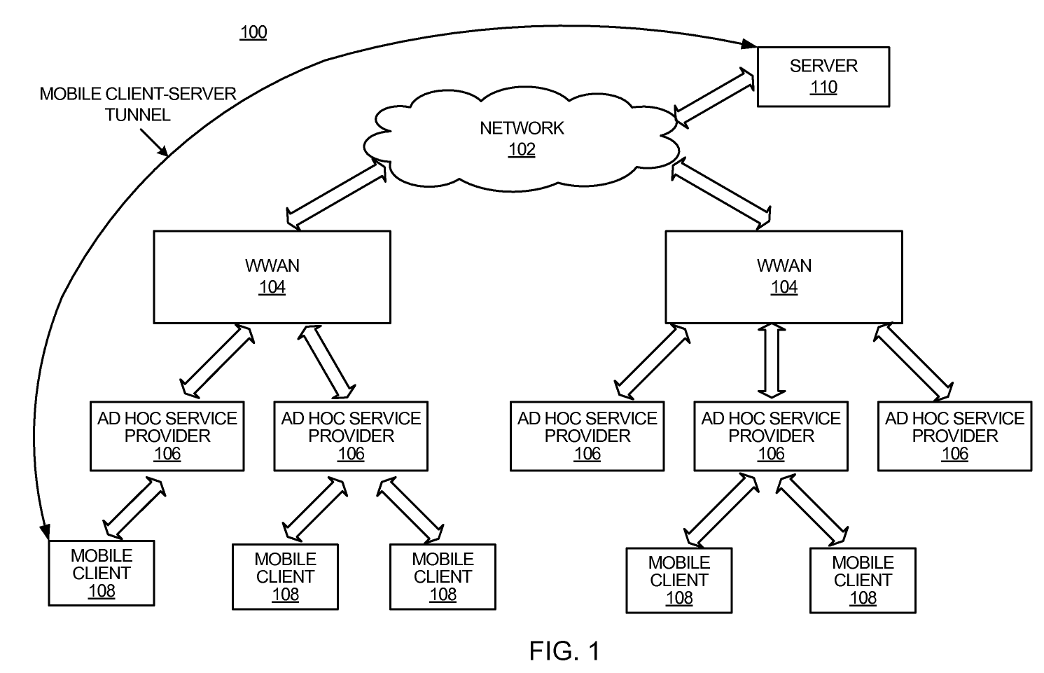

FIG. 1 is a simplified block diagram illustrating an example of a telecommunications system. The telecommunications system 100 is shown with multiple WWANs 104 that provide broadband access to a network 102 for mobile subscribers. The network 102 may be a packet-based network such as the Internet or an intranet. For clarity of presentation, two WWANs 104 are shown with a backhaul connection to the network 102. However, the number of WWANs providing broadband access to the network 102 is not limited to two WWANs. Each WWAN 104 may be implemented with multiple fixed-site base stations (not shown) dispersed throughout a geographic region. The geographic region may be generally subdivided into smaller regions known as cells. Each base station may be configured to serve all mobile subscribers within its respective cell. A base station controller (not shown) may be used to manage and coordinate the base stations in the WWAN 104 and support the backhaul connection to the network 102.

Each WWAN 104 may use one of many different wireless access protocols to support radio communications with mobile subscribers. By way of example, one WWAN 104 may support Evolution-Data Optimized (EV-DO), while the other WWAN 104 may support Ultra Mobile Broadband (UMB). EV-DO and UMB are air interface standards promulgated by the 3rd Generation Partnership Project 2 (3GPP2) as part of the CDMA2000 family of standards and employ multiple access techniques such as Code Division Multiple Access (CDMA) to provide broadband Internet access to mobile subscribers. Alternatively, one of the WWANs 104 may support Long Term Evolution (LTE), which is a project within the 3GPP2 to improve the Universal Mobile Telecommunications System (UMTS) mobile phone standard based primarily on a Wideband CDMA (W-CDMA) air interface. One of the WWANs 104 may also support the WiMAX standard being developed by the WiMAX forum. The actual wireless access protocol employed by a WWAN for any particular telecommunications system will depend on the specific application and the overall design constraints imposed on the system. The various techniques presented throughout this disclosure are equally applicable to any combination of heterogeneous or homogeneous WWANs regardless of the wireless access protocols utilized.

Each WWAN 104 has a number of mobile subscribers. Each subscriber may have a mobile node capable of accessing the network 102 directly through the WWAN 104. In the telecommunications system shown in FIG. 1 as an example, these mobile nodes access the WWANs 104 using an EV-DO, UMB or LTE wireless access protocol; however, in actual implementations, these mobile nodes may be configured to support any wireless access protocol.

In the system of FIG. 1, one or more of the mobile nodes may be configured to create in its vicinity an ad hoc network based on the same or a different wireless access protocol used to access the WWAN(s) 104. By way of example, a mobile node may support a UMB wireless access protocol with a WWAN, while providing an IEEE 802.11 access point for other mobile nodes that cannot directly access a WWAN. IEEE 802.11 denotes a set of Wireless Local Access Network (WLAN) standards developed by the IEEE 802.11 committee for short-range communications (e.g., tens of meters to a few hundred meters). Although IEEE 802.11 is a common WLAN wireless access protocol, other suitable protocols may be used.

A mobile node that may be used to provide an access point for another mobile node will be referred to herein as an “ad hoc service provider” and is represented as an ad hoc service provider 106 in FIG. 1. A mobile node that may use an access point of an ad hoc service provider 106 will be referred to herein as a “mobile client” and is represented as a mobile client 108 in FIG. 1. A mobile node, whether an ad hoc service provider 106 or a mobile client 108, may be a laptop computer, a mobile telephone, a personal digital assistant (PDA), a mobile digital audio player, a mobile game console, a digital camera, a digital camcorder, a mobile audio device, a mobile video device, a mobile multimedia device, a component(s) of any of the foregoing (such as a printed circuit board(s), an integrated circuit(s), and/or a circuit component(s)), or any other device capable of supporting at least one wireless access protocol.

The ad hoc service provider 106 may extend its wireless broadband network access service to mobile clients 108 that would otherwise not have access to the network 102. A server 110 may be used as an “exchange” to enable mobile clients 108 to purchase unused bandwidth from ad hoc service providers 106 to access, for example, the network 102 across the WWANs 104.

An ad hoc service provider 106, a server 1 10, and one or more mobile clients 108 may establish a network that is an ad hoc heterogeneous wireless network. By way of example, a heterogeneous wireless network may include at least two types of wireless networks (e.g., a WWAN and a WLAN). By way of example, an ad hoc network may be a network whose specific configuration may change from time to time or from the formation of one network to the next. The network configuration is not pre-planned prior to establishing the network. Examples of configurations for an ad hoc network may include a configuration as to which members are to be in the network (e.g., which ad hoc service provider, which server, and/or which mobile client(s) are to be included in a network), a configuration as to the geographic locations of an ad hoc service provider and mobile client(s), and a configuration as to when and how long a network is to be established.

For illustrative purposes only, exemplary scenarios of ad hoc networks are described below. Scenario 1: While a mobile subscriber is at an airport on Tuesday 8 am, he may turn on his mobile node (e.g., a laptop computer or a mobile telephone), use it as an ad hoc service provider while he is waiting for his flight, and establish an ad hoc network for 30 minutes. The ad hoc network may include one or more mobile clients (e.g., other laptop computers or mobile telephones) in the vicinity. Scenario 2: On Wednesday 5 pm, while the mobile subscriber is at a hotel, he may use the same mobile node as an ad hoc service provider to form another ad hoc network for four hours, providing its service to the same mobile clients, different mobile clients, or a combination of both. Scenario 3: On Wednesday 5 pm, a different ad hoc service provider may form an ad hoc network at the airport where the first ad hoc service provider was the day before. Because the service providers and clients are mobile, an ad hoc network can be a “mobile” network.

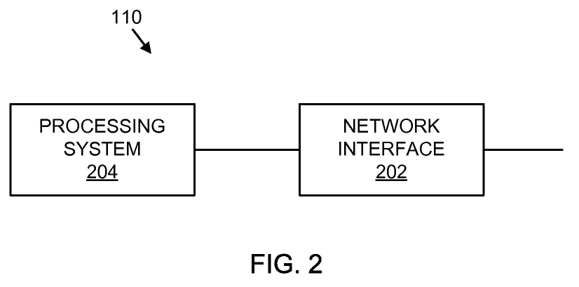

FIG. 2 is a simplified block diagram illustrating an example of a hardware configuration for a server. The server 110 may be a centralized server or a distributed server. The centralized server may be a dedicated server or integrated into another entity such as a desktop or laptop computer, or a mainframe. The distributed server may be distributed across multiple servers and/or one or more other entities such as laptops or desktop computers, or mainframes. In at least one configuration, the server 110 may be integrated, either in whole or in part, into one or more ad hoc service providers. A server may be a communication device, a system including a communication device, or a component(s) of any of the foregoing (such as a printed circuit board(s), an integrated circuit(s), and/or a circuit component(s)).

The server 110 is shown with a network interface 202. The network interface 202 may be used to implement the physical layer with the network 102 (see FIG. 1). In addition, the network interface 202 may also be configured to implement the data link layer by managing the transfer of data across the physical layer.

The server 110 is also shown with a processing system 204. The processing system 204 may be implemented using software, hardware, or a combination of both, either in a dedicated server, or integrated into another entity, or distributed across multiple entities. By way of example, the processing system 204 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processing system 204 may also include one or more machine-readable media for storing software. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media may include storage integrated into a processor, such as might be the case with an ASIC. Machine-readable media may also include storage external to a processor, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. In addition, machine-readable media may include a transmission line or a carrier wave that encodes a data signal. Those skilled in the art will recognize how best to implement the described functionality for the processing system 204. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. Instructions may be executable, for example, by a mobile node or a server or by a processing system of a mobile node or a server. Instructions can be, for example, a computer program including code.

The processing system 204 may be used to implement various functions of the server 110. The functionality of the processing system 204 for one configuration of a server 110 will now be presented with reference to FIG. 1. Those skilled in the art will readily appreciate that other configurations of the server 110 may include a processing system that has the same or different functionality.

Turning to FIG. 1, the processing system in the server 110 provides a means for authenticating an ad hoc service provider 106 to provide a wireless access point to a network for mobile clients 108, a means for authenticating the mobile clients 108 to use the service provided by the ad hoc service provider 106, and a means for establishing tunnels between the server 110 and each of the mobile clients 108 through the ad hoc service provider 106. A tunnel between the server 110 and one of the mobile clients 108 is shown in FIG. 1.

In one configuration of a telecommunications system 100, the server 110 charges the mobile clients 108 based on usage. For the occasional user of mobile Internet services, this may be an attractive alternative to the monthly fixed rate wireless access plans. The processing system in the server 110 may provide the means for determining the charge to the mobile clients 108 for access to the network through the ad hoc service provider 106.

The revenue generated from the usage charges may be allocated to the various entities in the telecommunications system 100 in a way that tends to perpetuate the vitality of the exchange. By way of example, a portion of the revenue may be distributed to the ad hoc service providers, thus providing a financial incentive for mobile subscribers to become ad hoc service providers. Another portion of the revenue may be distributed to the WWAN operators to compensate them for the bandwidth that would otherwise go unutilized. Another portion of the revenue may be distributed to the manufacturers of the mobile nodes. The remainder of the revenue could be kept by the server operator that provides the exchange. The server 110 may provide the means for determining how to allocate revenue generated from the mobile clients 108 to the various entities in the telecommunications system 100.

The server 110 may be implemented as a trusted server. It can therefore be authenticated, for example, using a Public Key Infrastructure (PKI) certificate in a Transport Layer Security (TLS) session between the server 110 and an ad hoc service provider 106, or between the server 110 and a mobile client 108. Alternatively, the server 110 may be authenticated using self-signed certificates or by some other suitable means.

The processing system in the server 110 may also provide a means for registering the ad hoc service provider. A secure session channel may be established between the server 110 and an ad hoc service provider 106, or between the server 110 and a mobile client 108, during registration. In one configuration of a telecommunications system 100, a mobile client 108 may register with the server 110 to set up a user name and password with payment information. An ad hoc service provider 106 may register with the server 110 to notify its desire to provide a wireless access point (e.g., an Internet access point) to mobile clients 108.

The processing system 204 in the server 110 may also be used to provide admission control. Admission control is the process whereby the processing system determines whether to enable an ad hoc service provider 106 to provide a wireless access point within a geographic coverage region. The processing system may limit the number of ad hoc service providers 106 in any given coverage region if it determines that additional ad hoc service providers 106 will adversely affect performance in the WWAN. Additional constraints may be imposed by the WWAN operators that may not want its mobile subscribers to provide service in a given geographic coverage region depending on various network constraints.

In one configuration of the processing system, Extensible Authentication Protocol-Tunneled Transport Layer Security (EAP-TTLS) may be used for Authentication, Authorization and Accounting (AAA) and secure session establishment for a connection initiated by an ad hoc service provider 106 with the server 110 when the ad hoc service provider 106 is mobile and desires to provide service. EAP-TTLS may also be used for a session initiation request by a mobile client 108. In the latter case, the mobile client is the supplicant, the ad hoc service provider 106 is the authenticator, and the server 110 is the authentication server. The ad hoc service provider 106 sends the mobile client's credentials to the processing system in the server 110 for EAP-AAA authentication. The EAP-TTLS authentication response from the processing system is then used to generate a Master shared key. Subsequently, a link encryption key may be established between the ad hoc service provider 106 and the mobile client 108.

The processing system in the server 110 may also provide a means for establishing a connection with a mobile client 108 for encrypted data that cannot be deciphered by the ad hoc service provider 106. This may be achieved with a Secure Sockets Layer Virtual Private Network (SSL VPN) tunnel between a mobile client 108 and the server 110. The SSL VPN tunnel is used to encrypt traffic routed through an ad hoc service provider 106 to provide increased privacy for a mobile client 108. Alternatively, the tunnel may be an IPsec tunnel or may be implemented using some other suitable tunneling protocol.

Once the tunnel is established between the server 110 and the mobile client 108, various services may be provided. By way example, the processing system may support audio or video services to the mobile client 108. The processing system may also support advertising services to the mobile client 108. Other functions of the processing system include providing routing to and from the network for mobile client 108 content as well as providing network address translation to and from the network for the mobile client 108.

The processing system in the server 110 may also provide a means for supporting for a handoff of a mobile client 108 from one ad hoc service provider 106 to another based on any number of factors. These factors may include, by way of example, the quality of service (QoS) required by each mobile client 108, the duration of the session required by each mobile client 108, and the loading, link conditions, and energy level (e.g., battery life) at the ad hoc service provider 106. The handoff may be a soft handoff wherein the processing system maintains the tunnel in a persistent state during handoff.

The server 110 may also be used to store a quality metric for each ad hoc service provider 106. This quality metric may be provided to the mobile clients 108 who may want to choose from available ad hoc service providers 106. This metric may be continuously updated as more information becomes available about a specific ad hoc service provider 106. The quality metric associated with each ad hoc service provider 106 may be decreased or increased based on the QoS provided.

Briefly stated, the server 110 may be configured to receive the necessary operating parameters of the ad hoc networks under its control. The server 110 may arrange and make available such operating parameters to existent communication entities and other communication entities not yet joining the ad hoc networks for participation. The aforementioned communication entities may be the service providers 106 and the mobile clients 108. The operating parameters may include, among other things, the number of ad hoc networks under the control of the server 110; the number of clients 108 in each ad hoc network; the relative and absolute locations of the clients 108 and the ad hoc networks; the security and/or encryption parameters needed for participating the ad hoc networks; identities, capabilities and loadings of each ad hoc network; and information relating to each service provider 106 such as available bandwidth, processing power, remaining battery life, available duration of usage, charge of service, etc. The operating parameters may be updated dynamically by the server 110 and made available on demand to the communication entities, such as the providers 106 and the clients 108, instantaneously.

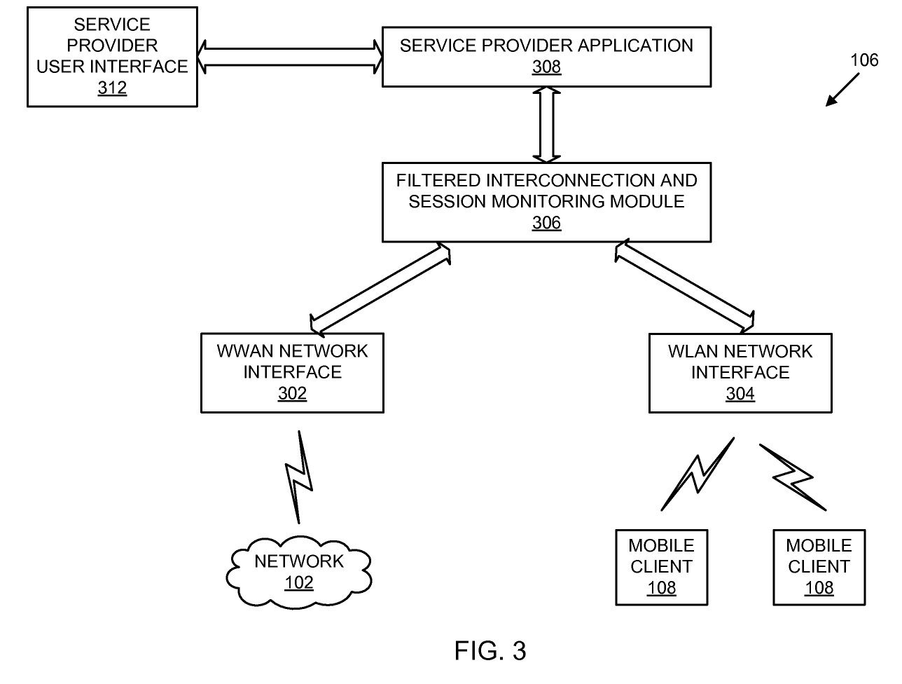

FIG. 3 is a simplified block diagram illustrating an example of the functionality of an ad hoc service provider 106. The ad hoc service provider 106 has the ability to bridge wireless links over homogeneous or heterogeneous wireless access protocols. This may be achieved with a WWAN network interface 302 that supports a wireless access protocol for a WWAN 104 to the network 102, and a WLAN network interface 304 that provides a wireless access point for mobile clients 108. By way of example, the WWAN network interface 302 may include a transceiver function that supports EV-DO for network access (e.g., Internet access) through a WWAN 104, and the WLAN network interface 304 may include a transceiver function that provides an 802.11 access point for mobile clients 108. Each network interface 302, 304 may be configured to implement the physical layer by demodulating wireless signals and performing other radio frequency (RF) front end processing. Each network interface 302, 304 may also be configured to implement the data link layer by managing the transfer of data across the physical layer.

The ad hoc service provider 106 is shown with a filtered interconnection and session monitoring module 306. The module 306 provides filtered processing of content from mobile clients 108 so that the interconnection between the ad hoc wireless links to the WWAN network interface 302 is provided only to mobile clients 108 authenticated and permitted by the server to use the WWAN network. The module 306 may also maintain tunneled connectivity between the server 110 and the authenticated mobile clients 108.

The ad hoc service provider 106 also includes a service provider application 308 that (1) enables the module 306 to provide ad hoc services to mobile clients 108, and (2) supports WWAN or Internet access to a mobile subscriber or user of the ad hoc service provider 106. The latter function is supported by a service provider user interface 312 that communicates with the WWAN network interface 302 through the module 306 under control of the service provider application 308. The user interface 312 may include a keypad, display, speaker, microphone, joystick, and/or any other combination of user interface devices that enable a mobile subscriber or user to access the WWAN 104 or the network 102 (see FIG. 1). A mobile subscriber may also use the user interface 312 to provide input to a processing system of the ad hoc service provider or to view an output therefrom.

As discussed above, the service provider application 308 also enables the module 306 to provide ad hoc services to mobile clients 108. The service provider application 308 maintains a session with the server 110 to exchange custom messages with the server 110. In addition, the service provider application 308 maintains a separate session with each mobile client 108 for exchanging custom messages between the service provider application 308 and the mobile client 108. The service provider application 308 provides information on authenticated and permitted clients to the filtered interconnection and session monitoring module 306. The filtered interconnection and session monitoring module 308 allows content flow for only authenticated and permitted mobile clients 108. The filtered interconnection and session monitoring module 306 also optionally monitors information regarding content flow related to mobile clients 108 such as the amount of content outbound from the mobile clients 108 and inbound to the mobile clients 108, and regarding WWAN and WLAN network resource utilization and available bandwidths on the wireless channels. The filtered interconnection and session monitoring module 306 can additionally and/or optionally provide such information to the service provider application 308. The service provider application 308 can additionally and/or optionally act on such information and take appropriate actions such as determining whether to continue maintaining connectivity with the mobile clients 108 and with the server 110, or whether to continue to provide service. It should be noted that the functions described in connection with the modules 306 and 308 can be implemented in any given platform in one or multiple sets of modules that coordinate to provide such functionality at the ad hoc service provider 106.

When the ad hoc service provider 106 decides to provide the ad hoc services, the service provider application 308 sends a request to the server 110 for approval. The service provider application 308 requests authentication by the server 110 and approval from the server 110 to provide service to one or more mobile clients 108. The server 110 may authenticate the ad hoc service provider 106 and then determine whether it will grant the ad hoc service provider's request. As discussed earlier, the request may be denied, for example, if the number of ad hoc service providers in the same geographic location is too great or if the WWAN operator has imposed certain constraints on the ad hoc service provider 106.

Once the ad hoc service provider 106 is authenticated, the service provider application 308 may advertise an ad hoc WLAN Service Set Identifier (SSID). Interested mobile clients 108 may associate with the SSID to access the ad hoc service provider 106. The service provider application 308 may then authenticate the mobile clients 108 with the server 110 and then configure the filtered interconnection and session monitoring module 306 to connect the mobile clients 108 to the server. During the authentication of a mobile client 108, the service provider application 308 may use an unsecured wireless link.

The service provider application 308 may additionally and/or optionally choose to move a mobile client 108 to a new SSID with a secure link once the mobile client 108 is authenticated. In such situations, the service provider application 308 may distribute the time it spends in each SSID depending on the load that it has to support for existing sessions with mobile clients 108.

The service provider application 308 may also be able to determine whether it can support a mobile client 108 before allowing the mobile client 108 to access a network. Resource intelligence that estimates the drain on the battery power and other processing resources that may be required by accepting a mobile client 108 may assist in determining whether the service provider application 308 should consider supporting a new mobile client 108 or accepting a handoff of that mobile client 108 from another ad hoc service provider 106.

The service provider application 308 may admit mobile clients 108 and provide them with a certain QoS guarantee, such as an expected average bandwidth during a session. Average throughputs provided to each mobile client 108 over a time window may be monitored. The service provider application 308 may monitor the throughputs for all flows going through it to ensure that resource utilization by the mobile clients 108 is below a certain threshold, and that it is meeting the QoS requirement that it has agreed to provide to the mobile clients 108 during the establishment of the session.

The service provider application 308 may also provide a certain level of security to the wireless access point by routing content through the filtered interconnection and session monitoring module 306 without being able to decipher the content. Similarly, the service provider application 308 may be configured to ensure content routed between the user interface 312 and the WWAN 104 via the module 306 cannot be deciphered by mobile clients 108. The service provider application 308 may use any suitable encryption technology to implement this functionality.

The service provider application 308 may also maintain a time period for a mobile client 108 to access a network. The time period may be agreed upon between the service provider application 308 and the mobile client 108 during the initiation of the session. If the service provider application 308 determines that it is unable to provide the mobile client 108 with access to the network for the agreed upon time period, then it may notify both the server 110 and the mobile client 108 regarding its unavailability. This may occur due to energy constraints (e.g., a low battery), or other unforeseen events. The server 110 may then consider a handoff of the mobile client 108 to another ad hoc service provider 106, if there is such an ad hoc service provider in the vicinity of the mobile client 108. The service provider application 308 may support the handoff of the mobile client 108.

The service provider application 308 may also dedicate processing resources to maintain a wireless link or limited session with mobile clients 108 served by other ad hoc service providers 106. This may facilitate the handoff of mobile clients 108 to the ad hoc service provider 106.

The service provider application 308 may manage the mobile client 108 generally, and the session specifically, through the user interface 312. Alternatively, the service provider application 308 may support a seamless operation mode with processing resources being dedicated to servicing mobile clients 108. In this way, the mobile client 108 is managed in a way that is transparent to the mobile subscriber of the ad hoc service provider. The seamless operation mode may be desired where the service provider does not want to be managing mobile clients 108, but would like to continue generating revenue by sharing bandwidth with mobile clients 108.

Turning now to the mobile client in FIG. 1, a TLS session may be used by the mobile client 108 to register with the server 110. Once registered, the mobile client 108 may search for available ad hoc service providers 106. When the mobile client 108 detects the presence of one or more ad hoc service providers 106, it may initiate a session using EAP-TTLS with an ad hoc service provider 106 based on attributes and parameters such as the available bandwidth that the ad hoc service provider 106 can support, the QoS metric of the ad hoc service provider 106, and the cost of the service advertised. As described earlier, a link encryption key may be established between the mobile client 108 and the ad hoc service provider 106 during the establishment of the session. An SSL VPN session may be established between the mobile client 108 and the server 110 so that all traffic between the two is encrypted. The transport layer ports may be kept in the open and not encrypted to provide visibility for the network address translation functionality at the ad hoc service provider 106.

A handoff of a mobile client 108 from one ad hoc service provider to another may occur due to any of a number of factors. In one configuration, the mobile client 108 may maintain a limited session with multiple ad hoc service providers 106, while using one ad hoc service provider 106 to access the Internet. As described earlier, this approach may facilitate the handoff process. In an alternative configuration, the mobile client 108 may consider a handoff only when necessary. In this configuration, the mobile client 108 may maintain an active list of ad hoc service providers 106 in its vicinity for handoff. The mobile client 108 may select an ad hoc service provider 106 for handoff from the active list when the current ad hoc service provider 106 needs to discontinue its service. When handoff is not possible, a mobile client 108 may need to reconnect through a different ad hoc service provider 106 to access the Internet. Persistence of the tunnel (FIG. 1) between the mobile client and the server can enable a soft handoff of a mobile client from one service provider to another service provider.

If the bandwidth needs of a mobile client 108 are greater than the capabilities of the available ad hoc service providers 106, then the mobile client 108 may access multiple ad hoc service providers 106 simultaneously. A mobile client 108 with multiple transceivers could potentially access multiple ad hoc service providers 106 simultaneously using a different transceiver for each ad hoc service provider 106. If the same wireless access protocol can be used to access multiple ad hoc service providers 106, then different channels may be used. If the mobile client 108 has only one transceiver available, then it may distribute the time that it spends accessing each ad hoc service provider 106.

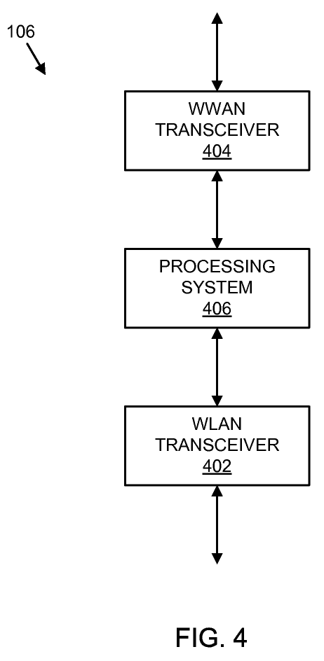

FIG. 4 is a simplified block diagram illustrating an example of a hardware configuration for an ad hoc service provider. The ad hoc service provider 106 is shown with a WLAN transceiver 402, a WWAN transceiver 404, and a processing system 406. By way of example, the WLAN transceiver 402 may be used to implement, for example, the analog portion of the physical layer for the WLAN network interface 304 (see FIG. 3), and the WWAN transceiver 404 may be used to implement, for example, the analog portion of the physical layer for the WWAN network interface 302 (see FIG. 3).

The processing system 406 may be implemented using software, hardware, or a combination of both. By way of example, the processing system 406 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processing system 406 may also include one or more machine-readable media for storing software. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media may include storage integrated into a processor, such as might be the case with an ASIC. Machine-readable media may also include storage external to a processor, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. In addition, machine-readable media may include a transmission line or a carrier wave that encodes a data signal. Those skilled in the art will recognize how best to implement the described functionality for the processing system 406. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. Instructions may be executable, for example, by a mobile node or a server or by a processing system of a mobile node or a server. Instructions can be, for example, a computer program including code.

The processing system 406 may be used to implement, for example, the digital processing portion of the physical layer, as well as the link layer, for both the WLAN and WWAN network interfaces 304 and 302 (see FIG. 3). The processing system 406 may also be used to implement the filtered interconnection and session monitoring module 306 and the service provider application 308.

The functionality of a processing system 406 for one configuration of an ad hoc service provider 106 will be presented in more detail later. Those skilled in the art will readily appreciate that other configurations of the ad hoc service provider 106 may include a processing system that has the same or different functionality.

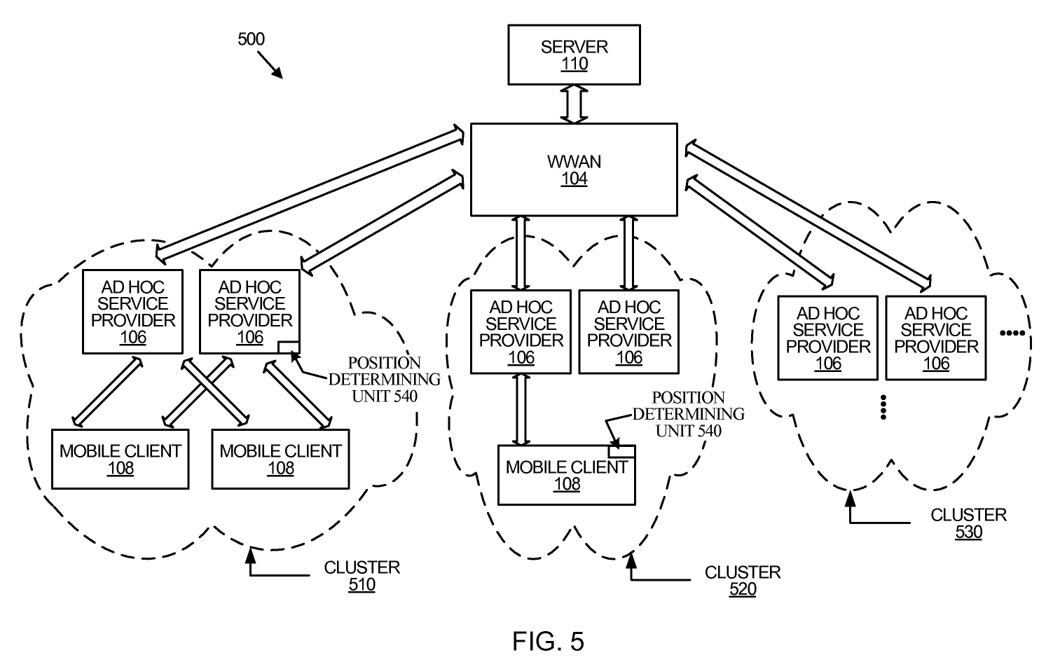

FIG. 5 is a simplified block diagram illustrating an example of a telecommunications system having clusters. When ad hoc clusters are formed and at least one mobile node of each cluster has the capability to connect to multiple wireless networks, that mobile node may be used as a routing node for the wireless networks. An exemplary telecommunications system 500 may include a server 110, a WWAN 104 and one or more ad hoc networks such as ad hoc clusters 510, 520 and 530. While three clusters are shown for illustration purposes, a system may include any number of clusters, and each cluster may include at least one ad hoc service provider 106 and any number of mobile clients 108 that can be supported by the cluster. Some of the mobile nodes may be included in more than one cluster. By way of example, an ad hoc service provider 106 in each cluster may support multiple wireless networks such as WWAN and WLAN and may be used as the routing node for one network to another (e.g., WLAN to WWAN).

In one configuration of the system 500, a processing system 204 (see FIG. 2) of the server 110 may provide a means for registering a first ad hoc service provider 106 and a means for registering a second ad hoc service provider 106. The processing system 204 may further provide a means for receiving from the first ad hoc service provider 106 information regarding the second ad hoc service provider 106. The information comprises service information of the second ad hoc service provider 106.

A processing system 406 (see FIG. 4) of an ad hoc service provider 106 in a cluster 510, 520, or 530 may provide a means for receiving information regarding a second ad hoc service provider 106. The information comprises service information of the second ad hoc service provider 106. The processing system 406 of the ad hoc service provider 106 may further include a means for supporting transmission of the information to a server 110 and a means for supporting an access point to a network (e.g., a WWAN 104) for a mobile client 108.

The processing system 406 of the ad hoc service provider 106 may further provide a means for supporting the access point by bridging a first wireless link with the mobile client 108 to a second wireless link with the network. The first wireless link may use a first wireless access protocol, and the second wireless link may use a second wireless access protocol different from the first wireless access protocol. Alternatively, the first wireless access protocol may be the same as the second wireless access protocol. The processing system 406 may be coupled to a first wireless transceiver (e.g., a WLAN transceiver 402 in FIG. 4) to support the first wireless link using the first wireless access protocol and a second wireless transceiver (e.g., a WWAN transceiver 404 in FIG. 4) to support the second wireless link using the second wireless access protocol. The processing system 406 may also be coupled to the user interface 312 shown in FIG. 3 and may provide a means for enabling a user to access the network through the user interface 312.

For a system 500 that has clusters, it is desirable to have knowledge about the characteristics of the clusters (sometimes referred to herein as “cluster information”), including, for example, formation of clusters, lifetimes of the clusters, patterns of clustering of ad hoc service providers 106, the number of clusters in the system, the number of mobile clients 108 being served in each cluster, geographic locations of the clusters, and geographic locations of the members (e.g., ad hoc service providers 106 and mobile clients 108) of the clusters, and options for alternate ad hoc service providers. A processing system 204 of a server 110 may include any or all of the cluster information. Having knowledge of the alternate ad hoc service providers' locations in proximity to a cluster can provide the opportunity to offload one or more mobile clients 108 to new ad hoc service providers 106 (i) to obtain the optimal bandwidth allocated to each mobile client 108 in the system, (ii) to quickly adapt to changing conditions, such as the loss of an ad hoc service provider within the cluster, or (iii) to extend service for a mobile client by utilizing a new ad hoc service provider that has joined the network after the mobile client (for example, if the current ad hoc service provider for the mobile client is unable to provide service to the mobile client for the duration requested by the mobile client).

Referring to FIGS. 3, 4 and 5, each ad hoc service provider 106 may emit beacon information (e.g., a beacon frame) that includes its identifier (e.g., SSID) as well as service information indicating that the mobile node is an ad hoc service provider for a server 110. Other ad hoc service providers, having a processing system properly configured with software (e.g., an appropriate service provider application 308 and filtered interconnection and session monitoring module 306), hardware, or a combination thereof, can receive and store this beacon information including the service information and upload it to a processing system 204 of the server 110. Mobile clients 108, having a processing system properly configured with software (e.g., appropriate driver or code), hardware, or a combination thereof, may also receive and store this information including the service information and upload it to the processing system 204 of the server 110 either directly or through an ad hoc service provider. The processing system 204 can take the information uploaded from the ad hoc service providers 106 and from the mobile clients 108, and form an aggregate graph of cluster information. This can be used to define a cluster of mobile nodes. If any reporting member of the cluster (e.g., an ad hoc service provider 106 or a mobile client 108) has a position determining unit 540 such as a global positioning system (GPS) unit, this can be used to assign a geographic location to the cluster.

The beacon information that includes service information of an ad hoc service provider 106 allows a mobile client 108 to discriminate between ad hoc service providers that are registered with the server 110 and other nodes that are not registered with the server but simply provide wireless access points. Nodes that are not registered with the server 110 and thus do not have the appropriate software to communicate with the server 110 can participate in the service. Mobile nodes (e.g., any ad hoc service provider or a mobile client) that are registered with the server 110 and thus have the appropriate software to communicate with the server can store the service information (e.g., valuable location and neighbor information) and upload it to the processing system 204 of the server 110.

The processing system 204 of the server 110 may then track the cluster information. The processing system 204 can track, for example, whether the same ad hoc service providers tend to form members of the same clusters and the randomness in the system. Knowledge of nearby ad hoc service providers can be disseminated to the mobile clients 108 of the system 500. If these mobile clients are not in range of the nearby ad hoc service providers but know that one of the ad hoc service providers is or was recently in close proximity, then these mobile clients may be willing to change locations to receive the service from the nearby ad hoc service providers. Knowledge of nearby ad hoc service providers can also be used for handoff to an ad hoc service provider when one ad hoc service provider gives notice that it will be terminating its service.

Each of the ad hoc service providers 106 and each of the mobile clients 108 can monitor beacon information from other ad hoc service providers and inform the processing system 204 of a server 110 of existing ad hoc service providers in the vicinity. The beacon information may include service information of the other ad hoc service providers. The service information may include one or more of the following information of the associated ad hoc service provider: channel information (e.g., the channel number supported by the ad hoc service provider), communication capacity (e.g., dynamic information about available capacity and utilized capacity at the ad hoc service provider), a duration of service provided by the ad hoc service provider, the geographic location of the ad hoc service provider, the price of service provided by the ad hoc service provider, a quality metric of the ad hoc service provider, and a quality of service provided by the ad hoc service provider. The pricing information may provide dynamic pricing capabilities based on demand. For example, if there are too many mobile clients compared to the number of available ad hoc service providers, then the price may increase. On the other hand, if the number of available mobile service provides is more numerous compared to the number of mobile clients, then the price may decrease.

Referring to FIGS. 2, 5, and 6a, an exemplary operation of acquiring ad hoc service provider topology knowledge is illustrated from a perspective of a server. In step 602, a processing system 204 of a server 110 may register a first ad hoc service provider 106. In step 604, the processing system 204 may also register a second ad hoc service provider 106. Many other ad hoc service providers 106 may also register with the processing system 204. Mobile clients 108 may also register with the processing system 204.

In step 606, the processing system 204 may receive from the first ad hoc service provider 106 information regarding the second ad hoc service provider 106. The information may comprise service information of the second ad hoc service provider 106. The information may have been emitted by the second ad hoc service provider 106. An ad hoc service provider 106 may transmit this information by broadcasting its beacon information including the service information. The processing system 204 may also receive, from a number of ad hoc service providers 106 and/or mobile clients 108, information regarding other ad hoc service providers. Each of such information may also include service information regarding its respective ad hoc service provider.

According to one aspect of the disclosure, the server 110 can receive the information wirelessly from the first ad hoc service provider 106 that receives the information wirelessly from the second ad hoc service provider 106. In another aspect, the server 110 can receive the information wirelessly from the first ad hoc service provider 106 after a mobile client 108 of the first ad hoc service provider 106 receives the information from the second ad hoc service provider 106 and sends the information to the first ad hoc service provider 106. The processing system 204 of the server 110 can support receiving the information by, for example, controlling or communicating with a transceiver or a receiver of the server 110.

Service information of the second ad hoc service provider 106 may include one or more of the following information about the second ad hoc service provider 106: channel information of the second ad hoc service provider 106, communication capacity of the second ad hoc service provider 106, a duration of service provided by the second ad hoc service provider 106, the location of the second ad hoc service provider 106, a price of service provided by the second ad hoc service provider 106, a quality metric of the second ad hoc service provider 106, and a quality of service provided by the second ad hoc service provider 106.

Now referring to FIGS. 2, 5, and 6b, the server 110 may perform additional functions such as those described below. In step 609, the processing system 204 of the server 110 may generate cluster information associated with the first and second ad hoc service providers and any other ad hoc service providers from which or about which the processing system has received information. In step 611, the processing system 204 may track the cluster information.

The cluster information may include one or more of the following: formation of clusters, lifetimes of the clusters, patterns of clustering, the number of clusters, the number of mobile clients in each of the clusters, information about alternate ad hoc service providers, geographic locations of the clusters, and geographic locations of members of the clusters.

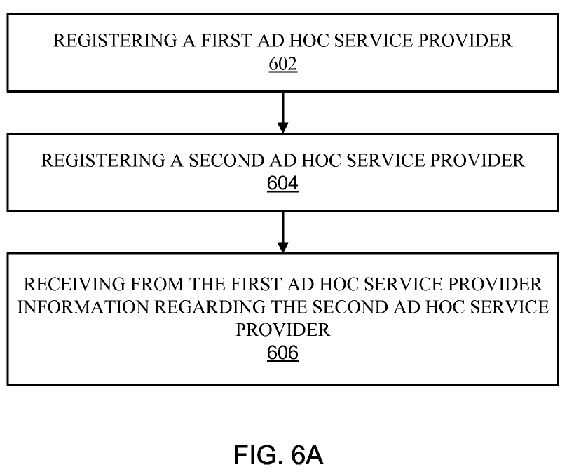

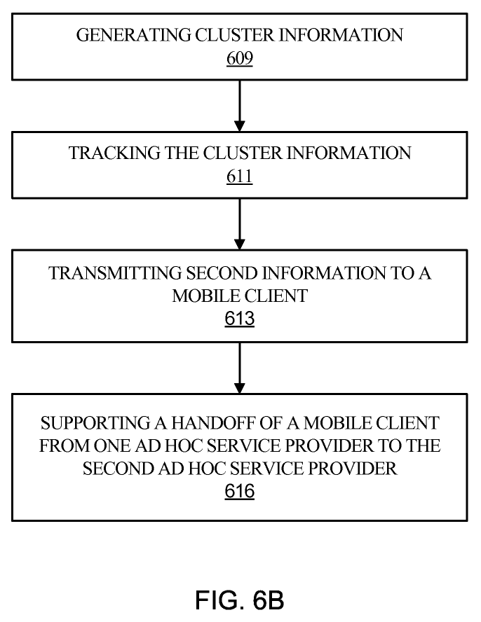

The processing system 204 of the server 110 may then generate second information regarding the second ad hoc service provider 106. The second information can be based on the information that the processing system 204 has previously received from the first ad hoc service provider (see, e.g., step 606 in FIG. 6a). The second information can be the same or different from the original information.

The second information may include one or more of the following information about the second ad hoc service provider 106: channel information of the second ad hoc service provider 106, communication capacity of the second ad hoc service provider 106, a duration of service provided by the second ad hoc service provider 106, the location of the second ad hoc service provider 106, a price of service provided by the second ad hoc service provider 106, a quality metric of the second ad hoc service provider 106, and a quality of service provided by the second ad hoc service provider 106.

In step 613, the server 110 may transmit the second information to a mobile client 108 that has access to the server 110 through a wireless access point provided by an ad hoc service provider 106. The processing system 204 of the server 110 can support transmission of the second information by, for example, controlling or communicating with a transceiver or a transmitter of the server 110. When the second information is transmitted to the mobile client 108, it enables the mobile client 108 to locate the second ad hoc service provider 106 whose beacon signal is not detectable by the mobile client 108 but which is physically in proximity to the mobile client 108. The server 110 can transmit the second information to a number of mobile clients that are in physical proximity to the second ad hoc service provider 106 through one or more ad hoc service providers.

In step 616, the processing system 204 of the server 110 may support a handoff of a mobile client 108 from one ad hoc service provider 106 to the second ad hoc service provider 106 based on at least the information about the second ad hoc service provider 106.

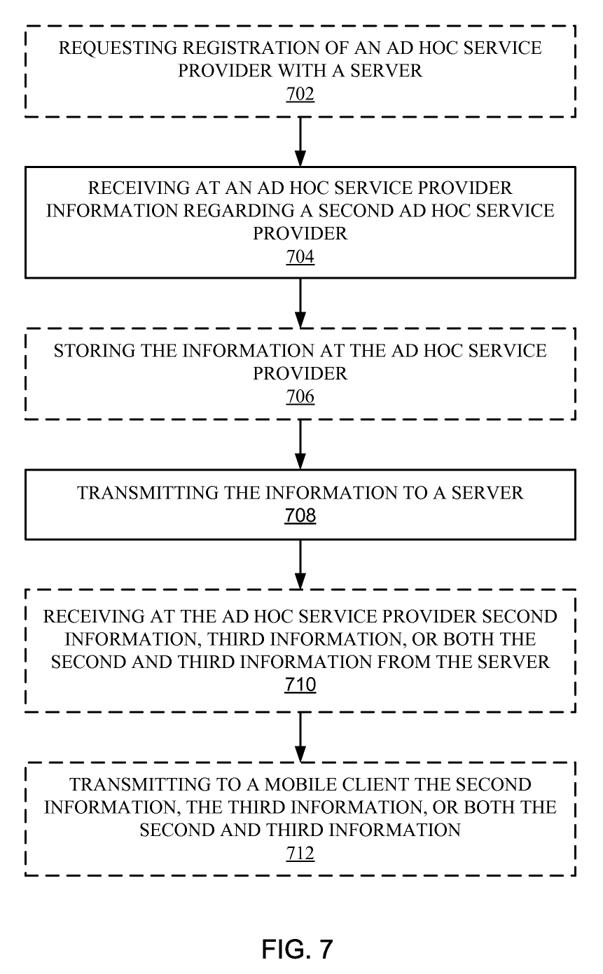

Referring to FIGS. 4, 5, and 7, an exemplary operation of acquiring and distributing network topology knowledge is illustrated from a perspective of an ad hoc service provider. The dotted boxes including steps 702, 706, 710 and 712 may be optional steps. In step 702, a processing system 406 of an ad hoc service provider 106 may request registration of an ad hoc service provider 106 with a server 110. A second ad hoc service provider 106 may be registered with the server 110, and a mobile client 108 may be also registered with the server 110. Many other mobile nodes (e.g., ad hoc service providers and mobile clients) can be also registered with the server 110.

After a mobile node registers with the server 110, the mobile node may obtain software for performing various functions described herein. Such software may be downloaded from the server 110, obtained on a disk such as a CD-ROM or DVD, or obtained in any other suitable manner. The software may be loaded onto a processing system of an ad hoc service provider 106 or a mobile client 108. The software for an ad hoc service provider 106 may be different from the software for a mobile client 108. It is also possible that hardware or a combination of hardware and software may be used instead of using software. A processing system of an ad hoc service provider 106 and a mobile client 108 may be implemented with such hardware or a combination of hardware and software.

In step 704, the processing system 406 of the ad hoc service provider 106 may receive information regarding the second ad hoc service provider 106. The ad hoc service provider 106 may be configured to support an access point to a network for a mobile client 108. The second ad hoc service provider 106 may also be configured to support an access point to the network for a second mobile client 108. The information comprises service information of the second ad hoc service provider 106. The information may have been emitted by the second ad hoc service provider 106. The information may comprise the beacon information of the second ad hoc service provider 106. The ad hoc service provider 106 may receive the information by monitoring the beacon information broadcasted by the second ad hoc service provider 106. The processing system 406 supports monitoring the beacon information by, for example, controlling or communicating with a transceiver or a receiver of the ad hoc service provider 106. The processing system 406 may also receive from other ad hoc service providers 106, or one or more of its mobile clients 108, information regarding the other ad hoc service providers 106. Each of such information may also include service information regarding its respective ad hoc service provider.

The ad hoc service provider 106 may receive the information wirelessly from the second ad hoc service provider 106 or receive the information wirelessly from the mobile client 108 after the mobile client 108 receives the information wirelessly from the second ad hoc service provider 106. The processing system 406 of the ad hoc service provider 106 may support reception of the information by, for example, controlling or communicating with a transceiver or receiver of the ad hoc service provider 106.

The service information may comprise service attributes of access to the network offered by the second ad hoc service provider 106. The service information may comprise one or more of the following: channel information of the second ad hoc service provider 106, communication capacity of the second ad hoc service provider 106, a duration of service provided by the second ad hoc service provider 106, a location of the second ad hoc service provider 106, a price of service provided by the second ad hoc service provider 106, a quality metric of the second ad hoc service provider 106, and a quality of service provided by the second ad hoc service provider 106.

In step 706, the processing system 406 of the ad hoc service provider 106 may store the information. Then in step 708, the ad hoc service provider 106 may transmit the information to the server 110. The processing system 406 may support transmission of the information by, for example, controlling or communicating with a transceiver or transmitter of the ad hoc service provider 106.

In step 710, the processing system 406 of the ad hoc service provider 106 may receive second information, third information, or both the second and third information from the server 110. The second information is based on the information regarding the second ad hoc service provider 106, and the third information comprises information regarding a third ad hoc service provider 106. The second information may be the same or different from the original information. In step 712, the ad hoc service provider 106 may transmit the second information, the third information, or both the second and third information to the mobile client 108. The processing system 406 supports the transmission by, for example, controlling or communicating with a transceiver or transmitter of the ad hoc service provider 106.

The second information may comprise an identifier of the second ad hoc service provider 106 and may further comprise one or more of the following service information: channel information of the second ad hoc service provider 106, communication capacity of the second ad hoc service provider 106, a duration of service provided by the second ad hoc service provider 106, the location of the second ad hoc service provider 106, a price of service provided by the second ad hoc service provider 106, a quality metric of the second ad hoc service provider 106, and a quality of service provided by the second ad hoc service provider 106. The third information may comprise similar information of the third ad hoc service provider 106.

The communication capacity of the second ad hoc service provider 106 may comprise dynamic information about available capacity and utilized capacity at the second ad hoc service provider 106. The price of service provided by the second ad hoc service provider 106 may comprise dynamic pricing based on demand. The communication capacity of the third ad hoc service provider 106 may comprise dynamic information about available capacity and utilized capacity at the third ad hoc service provider 106. The price of service provided by the third ad hoc service provider 106 may comprise dynamic pricing based on demand.

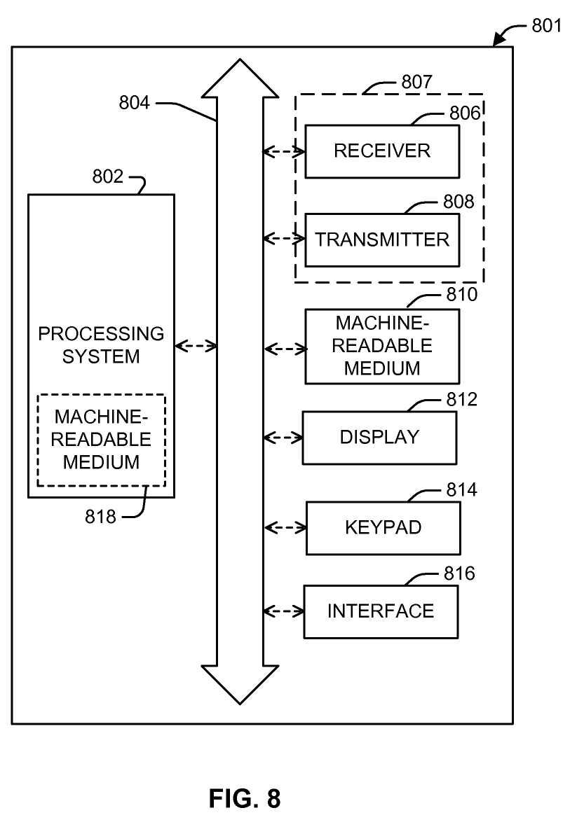

FIG. 8 is a simplified block diagram illustrating an example of a system. A system 801 may be a server 110 or an ad hoc service provider 106. The system 801 includes a processing system 802, which may be a processing system 204 of the server 110 or a processing system 406 of the ad hoc service provider 106. The processing system 802 is capable of communication with a receiver 806 and a transmitter 808 through a bus 804 or other structures or devices. It should be understood that communication means other than busses can be utilized with the disclosed configurations. The processing system 802 can generate audio, video, multimedia, and/or other types of data to be provided to the transmitter 808 for communication. In addition, audio, video, multimedia, and/or other types of data can be received at the receiver 806, and processed by the processing system 802.

The processing system 802 may include a general-purpose processor or a specific-purpose processor for executing instructions and may further include volatile or non-volatile memory for storing data and instructions for software programs. The instructions, which may be stored in a machine-readable medium 810 and/or 818, may be executed by the processing system 802 to control and manage access to the various networks, as well as provide other communication and processing functions. The instructions may also include instructions executed by the processing system 802 for various user interface devices, such as a display 812 and a keypad 814. A machine-readable medium (e.g., 810 and 818) can be in one or more of the various forms described in detail earlier in this disclosure, and particularly with reference to FIGS. 2 and 4 (e.g., a memory, a hard disk, a CD-ROM, a DVD, or any other suitable storage device). A machine-readable medium can be one or more machine-readable media. An interface 816 may be any type of interface and may reside between any of the components shown in FIG. 8. An interface 816 may be, for example, the network interface 202 shown in FIG. 2. A transceiver block 807 may represent one or more transceivers, and each transceiver may include a receiver 806 and a transmitter 808. A transceiver block 807 may represent, for example, the WWAN transceiver 404 and the WLAN transceiver 402 in FIG. 4. A functionality implemented in a processing system 802 may be implemented in a portion of a receiver 806, a portion of a transmitter 808, a portion of a machine-readable medium 810, a portion of a display 812, a portion of a keypad 814, or a portion of an interface 816, and vice versa.

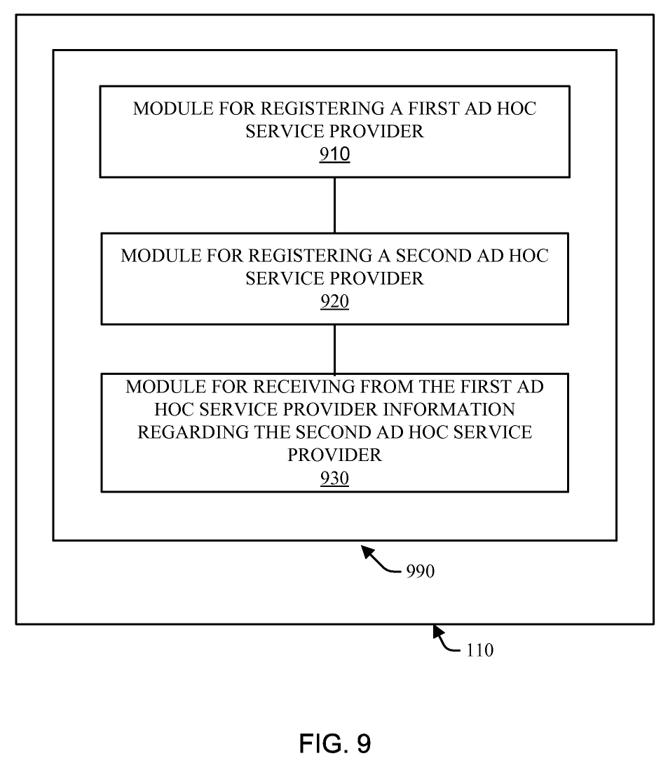

FIG. 9 is a simplified block diagram illustrating an example of the functionality of a server. A module 990 of a server 110 is configured with, or includes, a module 910 for registering a first ad hoc service provider and a module 920 for registering a second ad hoc service provider. The module 990 may be also configured with, or may include, a module 930 for receiving from the first ad hoc service provider information regarding the second ad hoc service provider. The information comprises service information of the second ad hoc service provider.

It should be noted that a module 990 may be, for example, a processing system (e.g., 204 of FIG. 2 or 802 of FIG. 8), a machine-readable medium (e.g., 810 or 818 of FIG. 8), or a combination of both. In one example, each of the modules 910, 920 and 930 may represent a portion of a processing system or a machine-readable medium configured with, or stored with, instructions for its corresponding functionality. For example, a module 910 in a machine-readable medium may be instructions stored in the machine-readable medium for registering a first ad hoc service provider. As for the module 930, it may be, for example, a portion of a processing system (e.g., 204 of FIG. 2 or 802 of FIG. 8), a network interface 202 of FIG. 2, a receiver 806 of FIG. 8, or some combination of them.

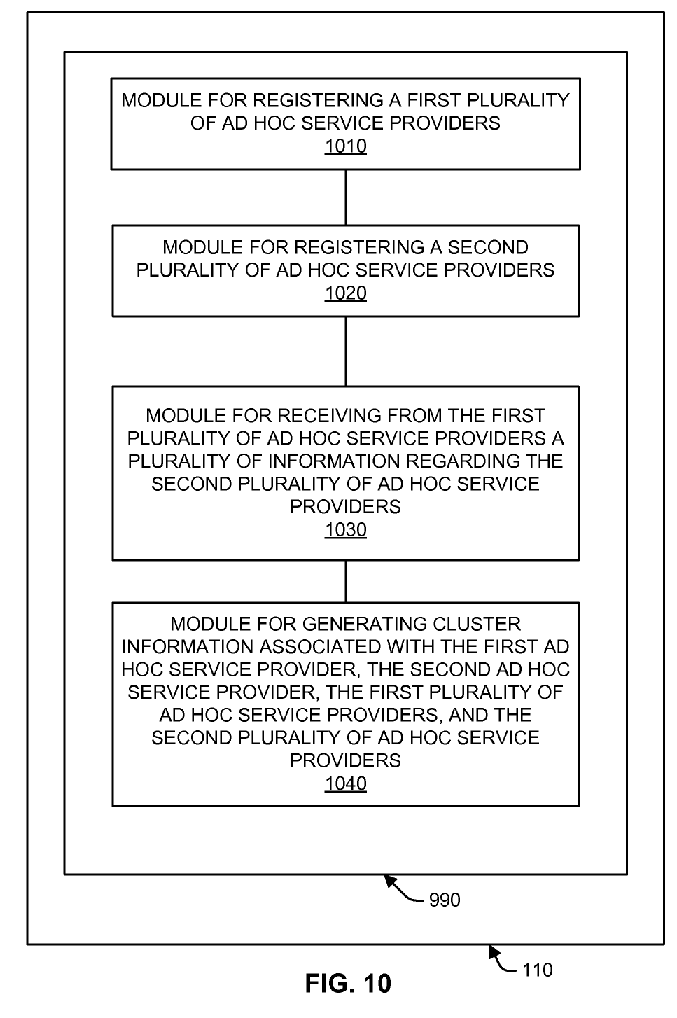

FIG. 10 is a simplified block diagram illustrating an example of the functionality of a server. A module 990 of a server 110 may be configured with, or may include, a module 1010 for registering a first plurality of ad hoc service providers, a module 1020 for registering a second plurality of ad hoc service providers, and a module 1030 for receiving from the first plurality of ad hoc service providers a plurality of information regarding the second plurality of ad hoc service providers. The plurality of information may be emitted by the second plurality of ad hoc service providers, and the plurality of information may comprise a plurality of service information of the second plurality of ad hoc service providers.

The module 990 may be further configured with, or may further include, a module 1040 for generating cluster information associated with the first ad hoc service provider, the second ad hoc service provider, the first plurality of ad hoc service providers, and the second plurality of ad hoc service providers. Each cluster may comprise at least one ad hoc service provider and at least one mobile client. In one example, each of the modules 1010, 1020, 1030 and 1040 may represent a portion of a processing system or a machine-readable medium configured with, or stored with, instructions for its corresponding functionality. As for the module 1030, it may be, for example, a portion of a processing system (e.g., 204 of FIG. 2 or 802 of FIG. 8), a portion of a network interface 202 of FIG. 2, a portion of a receiver 806 of FIG. 8, or some combination of them.

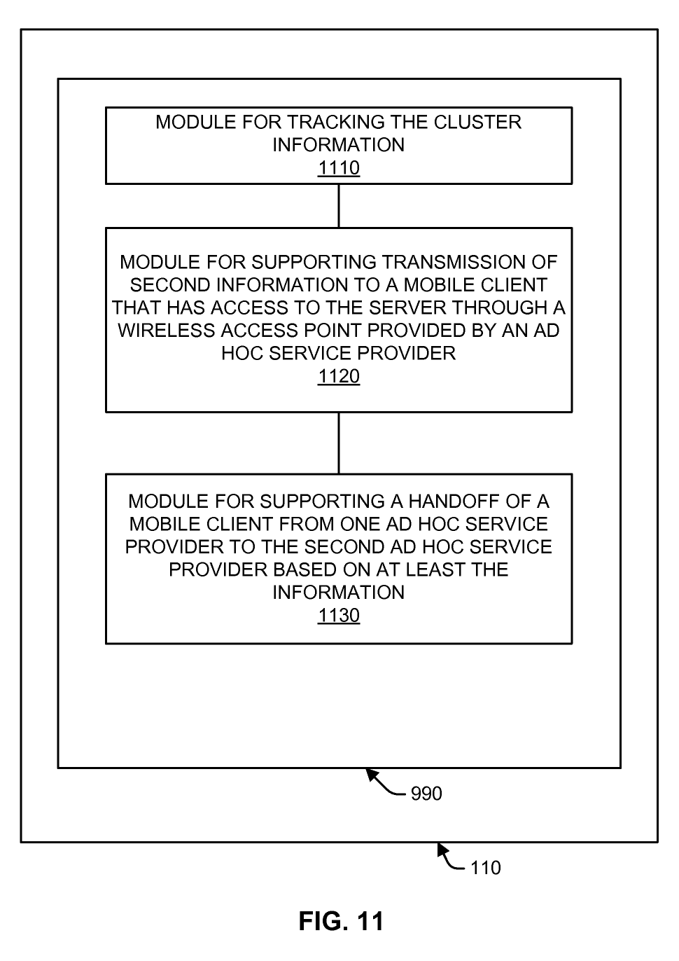

FIG. 11 is a simplified block diagram illustrating an example of the functionality of a server. A module 990 of a server 110 may be configured with, or may include, a module 1110 for tracking the cluster information. The cluster information may comprise one or more of the following: formation of clusters, lifetimes of the clusters, patterns of clustering, the number of clusters, the number of mobile clients in each of the clusters, information about alternate ad hoc service providers, geographic locations of the clusters, and geographic locations of members of the clusters.

The module 990 may be further configured with, or may further include, a module 1120 for supporting transmission of second information to a mobile client that has access to the server through a wireless access point provided by an ad hoc service provider. The second information may be based on the information regarding the second ad hoc service provider received by the server. The transmission of the second information to the mobile client may enable the mobile client to locate the second ad hoc service provider whose beacon signal is not detectable by the mobile client but which is physically in proximity to the mobile client.

The module 990 may be further configured with, or may further include, a module 1130 for supporting a handoff of a mobile client from one ad hoc service provider to the second ad hoc service provider based on at least the information. In one example, each of the modules 1110, 1120 and 1130 may represent a portion of a processing system or a machine-readable medium configured with, or stored with, instructions for its corresponding functionality.

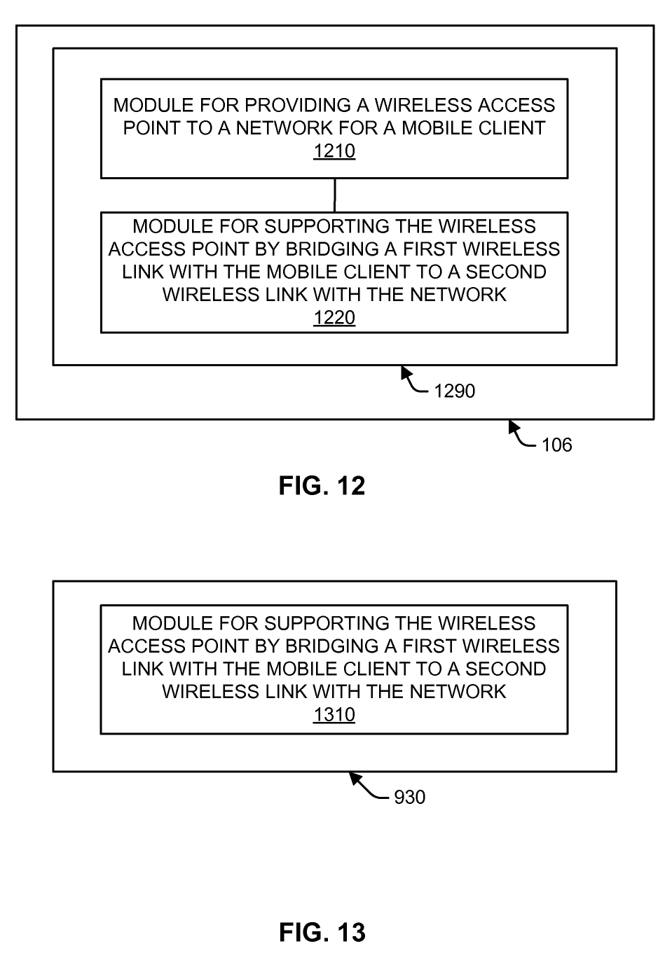

FIG. 12 is a simplified block diagram illustrating an example of the functionality of an ad hoc service provider. A module 1290 of a first ad hoc service provider 106 may be configured with, or may include, a module 1210 for providing a wireless access point to a network for a mobile client and a module 1220 for supporting the wireless access point by bridging a first wireless link with the mobile client to a second wireless link with the network. The first wireless link may use a first wireless access protocol. The second wireless link may use a second wireless access protocol different from the first wireless access protocol. The information may be emitted by the second ad hoc service provider.

It should be noted that a module 1290 may be, for example, a processing system (e.g., 406 of FIG. 4 or 802 of FIG. 8), a machine-readable medium (e.g., 810 or 818 of FIG. 8), or a combination of both. Each of the modules 1210 and 1220 may represent a portion of a processing system or a machine-readable medium configured with, or stored with, instructions for its corresponding functionality.

FIG. 13 is a simplified block diagram illustrating an example of the functionality of a module for receiving from a first ad hoc service provider information regarding a second ad hoc service provider. In this example, a module 930 of FIG. 9 may be configured with, or may include, a module 1310 for supporting reception of the information wirelessly from the first ad hoc service provider after a mobile client receives the information from the second ad hoc service provider and sends the information to the first ad hoc service provider. The module 1310 may represent a portion of a processing system or a machine-readable medium configured with, or stored with, instructions for its corresponding functionality.

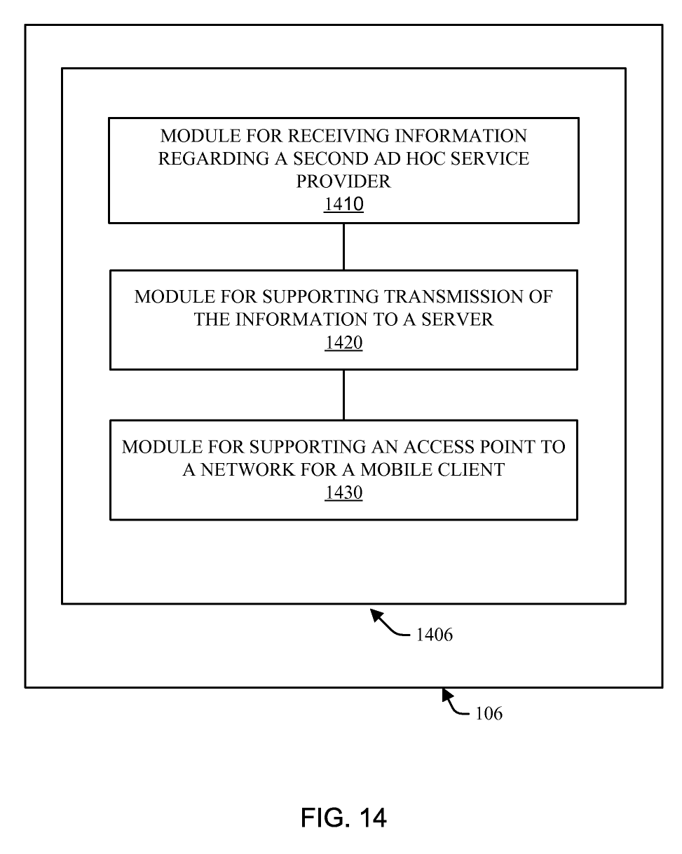

FIG. 14 is a simplified block diagram illustrating an example of the functionality of a processing system in an ad hoc service provider. A module 1406 of an ad hoc service provider 106 may be configured with, or may include, a module 1410 for receiving information regarding a second ad hoc service provider. The information comprises service information of the second ad hoc service provider. The module 1406 may be further configured with, or may further include, a module 1420 for supporting transmission of the information to a server and a module 1430 for supporting an access point to a network for a mobile client.

It should be noted that a module 1406 may be, for example, a processing system (e.g., 406 of FIG. 4 or 802 of FIG. 8), a machine-readable medium (e.g., 810 or 818 of FIG. 8), a transceiver (e.g., 404 or 402 of FIG. 4 or 807 of FIG. 8), an interface (e.g., 816 of FIG. 8), or a combination of some or all of them. In one example, each of the modules 1410, 1420 and 1430 may represent a portion of a processing system, a portion of a machine-readable medium, a portion of a transceiver, a portion of an interface, or a combination of some or all of them, that is/are configured with, or stored with, instructions or hardware for its corresponding functionality. For example, a module 1420 in a machine-readable medium may be instructions stored in the machine-readable medium for supporting transmission of the information to a server.

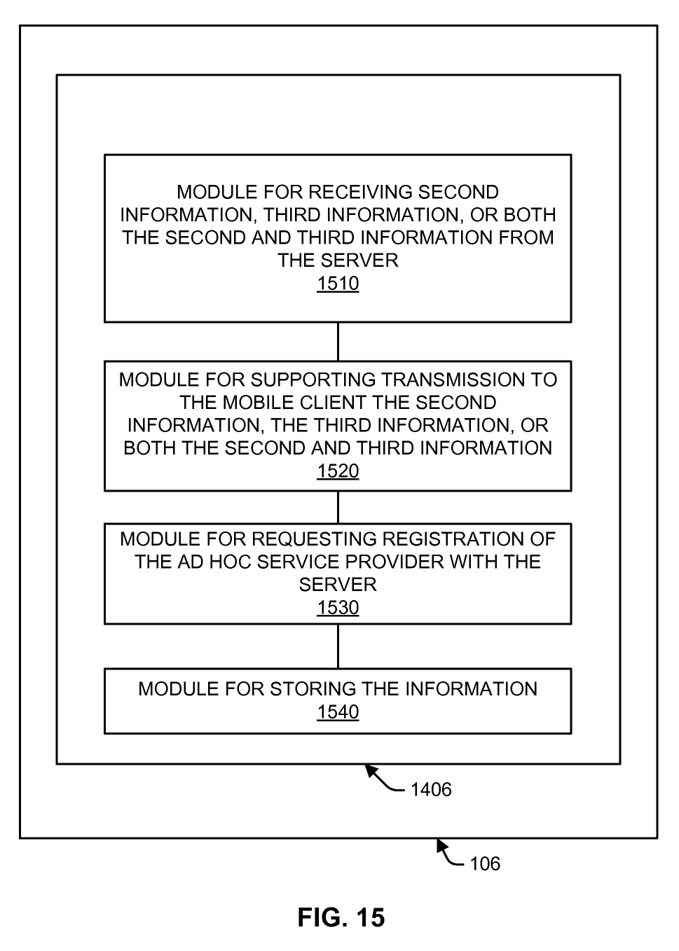

FIG. 15 is a simplified block diagram illustrating an example of the functionality of an ad hoc service provider. A module 1406 of an ad hoc service provider 106 may be configured with, or may include, a module 1510 for receiving second information, third information, or both the second and third information from the server. The second information may be based on the information regarding the second ad hoc service provider, and the third information may comprise information regarding a third ad hoc service provider.

The module 1406 may be further configured with, or may further include, a module 1520 for supporting transmission to the mobile client the second information, the third information, or both the second and third information. The module 1406 may be further configured with, or may further include, a module 1530 for requesting registration of the ad hoc service provider with the server. The second ad hoc service provider may be registered with the server, and the mobile client may be registered with the server. The module 1406 may be further configured with, or may further include, a module 1540 for storing the information. The information may be emitted by the second ad hoc service provider. In one example, each of the modules 1510, 1520, 1530 and 1540 may represent a portion of a processing system, a portion of a machine-readable medium, a portion of a transceiver, a portion of an interface, or a combination of some or all of them, that is/are configured with, or stored with, instructions or hardware for its corresponding functionality.

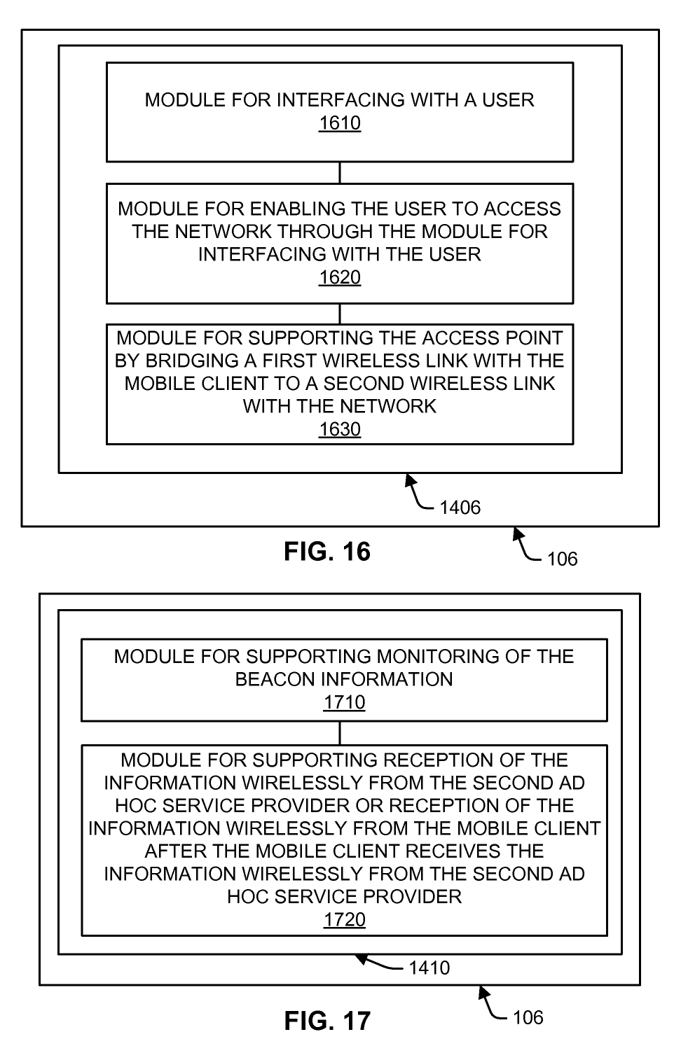

FIG. 16 is a simplified block diagram illustrating an example of the functionality of an ad hoc service provider. A module 1406 of an ad hoc service provider 106 may be configured with, or may include, a module 1610 for interfacing with a user, a module 1620 for enabling the user to access the network through the module 1620, and a module 1630 for supporting the access point by bridging a first wireless link with the mobile client to a second wireless link with the network. The first wireless link may use a first wireless access protocol. The second wireless link may use a second wireless access protocol different from the first wireless access protocol. In one example, each of the modules 1610, 1620 and 1630 may represent a portion of a processing system, a portion of a machine-readable medium, a portion of a transceiver, a portion of an interface, or a combination of some or all of them, that is/are configured with, or stored with, instructions or hardware for its corresponding functionality. The module 1610 may be, for example, a keypad 814 and/or a display 812.

FIG. 17 is a simplified block diagram illustrating an example of the functionality of a module for receiving information regarding a second ad hoc service provider. A module 1410 of an ad hoc service provider 106 may be configured with, or may include, a module 1710 for supporting monitoring of the beacon information and a module 1720 for supporting reception of the information wirelessly from the second ad hoc service provider or reception of the information wirelessly from the mobile client after the mobile client receives the information wirelessly from the second ad hoc service provider. In one example, each of the modules 1710 and 1720 may represent a portion of a processing system, a portion of a machine-readable medium, a portion of a transceiver, a portion of an interface, or a combination of some or all of them, that is/are configured with, or stored with, instructions or hardware for its corresponding functionality.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An ad hoc service provider, comprising:
a processing system configured to receive information regarding a second ad hoc service provider, the information comprising service information of the second ad hoc service provider, the processing system further configured to support transmission of the information to a server, the processing system further configured to support an access point to a network for a mobile client.

2. The ad hoc service provider of claim 1, wherein the information comprises beacon information broadcasted by the second ad hoc service provider, and wherein the processing system is further configured to support monitoring the beacon information to receive the information.

3. The ad hoc service provider of claim 1, wherein the service information comprises service attributes of access to the network offered by the second ad hoc service provider.

4. The ad hoc service provider of claim 1, wherein the service information comprises one or more of the following: a duration of service provided by the second ad hoc service provider, a location of the second ad hoc service provider, a price of service provided by the second ad hoc service provider, a quality metric of the second ad hoc service provider, and a quality of service provided by the second ad hoc service provider.

5. The ad hoc service provider of claim 1, wherein the service information comprises one or more of the following: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider.

6. The ad hoc service provider of claim 1, wherein the processing system is further configured to receive second information, third information, or both the second and third information from the server, the second information based on the information regarding the second ad hoc service provider, the third information comprising information regarding a third ad hoc service provider, and wherein the processing system is further configured to support transmitting to the mobile client the second information, the third information, or both the second and third information.

7. The ad hoc service provider of claim 6, wherein the second information comprises an identifier of the second ad hoc service provider and further comprises one or more of the following service information: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider, and
wherein the third information comprises an identifier of the third ad hoc service provider, and further comprises one or more of the following service information: channel information of the third ad hoc service provider, communication capacity of the third ad hoc service provider, a duration of service provided by the third ad hoc service provider, a location of the third ad hoc service provider, a price of service provided by the third ad hoc service provider, a quality metric of the third ad hoc service provider, and a quality of service provided by the third ad hoc service provider.

8. The ad hoc service provider of claim 7, wherein the communication capacity of the second ad hoc service provider comprises dynamic information about available capacity and utilized capacity at the second ad hoc service provider, wherein the price of service provided by the second ad hoc service provider comprises dynamic pricing based on demand, wherein the communication capacity of the third ad hoc service provider comprises dynamic information about available capacity and utilized capacity at the third ad hoc service provider, and wherein the price of service provided by the third ad hoc service provider comprises dynamic pricing based on demand.

9. The ad hoc service provider of claim 1, wherein the processing system is further configured to request registration of the ad hoc service provider with the server, wherein the second ad hoc service provider is registered with the server, and the mobile client is registered with the server.

10. The ad hoc service provider of claim 1, wherein the processing system is further configured to store the information, and
wherein the information is emitted by the second ad hoc service provider.

11. The ad hoc service provider of claim 1, wherein the ad hoc service provider is configured to receive the information wirelessly from the second ad hoc service provider or to receive the information wirelessly from the mobile client after the mobile client receives the information wirelessly from the second ad hoc service provider.

12. The ad hoc service provider of claim 1, wherein at least one of the ad hoc service provider, the second ad hoc service provider, and the mobile client comprises a position determining unit, and wherein the second ad hoc service provider is configured to support an access point to the network for a mobile client.

13. The ad hoc service provider of claim 1, further comprising a user interface, and the processing system is further configured to enable a user to access the network through the user interface.

14. The ad hoc service provider of claim 1, wherein the processing system is further configured to support the access point by bridging a first wireless link with the mobile client to a second wireless link with the network, wherein the first wireless link uses a first wireless access protocol, and wherein the second wireless link uses a second wireless access protocol different from the first wireless access protocol.

15. The ad hoc service provider of claim 1, wherein the ad hoc service provider is provided in one or more integrated circuits or one or more printed circuit boards.

16. An ad hoc service provider, comprising:
means for receiving information regarding a second ad hoc service provider, the information comprising service information of the second ad hoc service provider;
means for supporting transmission of the information to a server; and
means for supporting an access point to a network for a mobile client.

17. The ad hoc service provider of claim 16, wherein the information comprises beacon information broadcasted by the second ad hoc service provider, and wherein the means for receiving comprises means for supporting monitoring of the beacon information.

18. The ad hoc service provider of claim 16, wherein the service information comprises service attributes of access to the network offered by the second ad hoc service provider.

19. The ad hoc service provider of claim 16, wherein the service information comprises one or more of the following: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider.

20. The ad hoc service provider of claim 16, further comprising:
means for receiving second information, third information, or both the second and third information from the server, the second information based on the information regarding the second ad hoc service provider, the third information comprising information regarding a third ad hoc service provider; and
means for supporting transmission to the mobile client the second information, the third information, or both the second and third information.

21. The ad hoc service provider of claim 20, wherein the second information comprises an identifier of the second ad hoc service provider and further comprises one or more of the following service information: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider, and
wherein the third information comprises an identifier of the third ad hoc service provider, and further comprises one or more of the following service information: channel information of the third ad hoc service provider, communication capacity of the third ad hoc service provider, a duration of service provided by the third ad hoc service provider, a location of the third ad hoc service provider, a price of service provided by the third ad hoc service provider, a quality metric of the third ad hoc service provider, and a quality of service provided by the third ad hoc service provider.

22. The ad hoc service provider of claim 16, further comprising means for requesting registration of the ad hoc service provider with the server, wherein the second ad hoc service provider is registered with the server, and the mobile client is registered with the server.

23. The ad hoc service provider of claim 16, further comprising means for storing the information,
wherein the information is emitted by the second ad hoc service provider.

24. The ad hoc service provider of claim 16, the means for receiving comprises means for supporting reception of the information wirelessly from the second ad hoc service provider or reception of the information wirelessly from the mobile client after the mobile client receives the information wirelessly from the second ad hoc service provider.

25. The ad hoc service provider of claim 16, wherein at least one of the ad hoc service provider, the second ad hoc service provider, and the mobile client comprises a position determining unit, and wherein the second ad hoc service provider is configured to support an access point to the network for a mobile client.

26. The ad hoc service provider of claim 16, further comprising means for interfacing with a user and means for enabling the user to access the network through the means for interfacing with the user.

27. The ad hoc service provider of claim 16, further comprising means for supporting the access point by bridging a first wireless link with the mobile client to a second wireless link with the network, wherein the first wireless link uses a first wireless access protocol, and wherein the second wireless link uses a second wireless access protocol different from the first wireless access protocol.

28. A method of acquiring or distributing information related to one or more alternate ad hoc service providers, comprising:
receiving at an ad hoc service provider information regarding a second ad hoc service provider, the ad hoc service provider configured to support an access point to a network for a mobile client, the information comprising service information of the second ad hoc service provider; and
transmitting the information to a server in the network.

29. The method of claim 28, wherein the information comprises beacon information broadcasted by the second ad hoc service provider, and wherein the step of receiving comprises monitoring the beacon information.

30. The method of claim 28, wherein the service information comprises service attributes of access to the network offered by the second ad hoc service provider.

31. The method of claim 28, wherein the service information comprises one or more of the following: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider.

32. The method of claim 28, further comprising:
receiving at the ad hoc service provider second information, third information, or both the second and third information from the server, the second information based on the information regarding the second ad hoc service provider, the third information comprising information regarding a third ad hoc service provider; and
transmitting to the mobile client the second information, the third information, or both the second and third information.

33. The method of claim 32, wherein the second information comprises an identifier of the second ad hoc service provider and further comprises one or more of the following service information: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider, and
wherein the third information comprises an identifier of the third ad hoc service provider, and further comprises one or more of the following service information: channel information of the third ad hoc service provider, communication capacity of the third ad hoc service provider, a duration of service provided by the third ad hoc service provider, a location of the third ad hoc service provider, a price of service provided by the third ad hoc service provider, a quality metric of the third ad hoc service provider, and a quality of service provided by the third ad hoc service provider.

34. The method of claim 28, further comprising:
requesting registration of the ad hoc service provider with the server prior to the step of receiving, wherein the second ad hoc service provider is registered with the server, and the mobile client is registered with the server.

35. The method of claim 28, further comprising storing the information at the ad hoc service provider,
wherein the information is emitted by the second ad hoc service provider.

36. The method of claim 28, wherein the step of receiving comprises receiving the information wirelessly from the second ad hoc service provider or receiving the information wirelessly from the mobile client after the mobile client receives the information wirelessly from the second ad hoc service provider.

37. The method of claim 28, wherein at least one of the ad hoc service provider, the second ad hoc service provider, and the mobile client comprises a position determining unit, and wherein the second ad hoc service provider is configured to support an access point to the network for a mobile client.

38. The method of claim 28, wherein the ad hoc service provider comprises a user interface, and the method further comprises enabling a user to access the network through the user interface.

39. The method of claim 28, wherein the ad hoc service provider is further configured to support the access point by bridging a first wireless link with the mobile client to a second wireless link with the network, wherein the first wireless link uses a first wireless access protocol, and wherein the second wireless link uses a second wireless access protocol different from the first wireless access protocol.

40. A machine-readable medium comprising instructions executable by a processing system in a first mobile node, the instructions comprising code for:
receiving information regarding a second ad hoc service provider, the second ad hoc service provider configured to support an access point to a network for a mobile client, the information comprising service information of the second ad hoc service provider; and
supporting transmission of the information to a server in the network.

41. The machine-readable medium of claim 40, wherein the information comprises beacon information broadcasted by the second ad hoc service provider, and wherein the code for receiving comprises code for supporting monitoring of the beacon information.

42. The machine-readable medium of claim 40, wherein the service information comprises service attributes of access to the network offered by the second ad hoc service provider.

43. The machine-readable medium of claim 40, wherein the service information comprises one or more of the following: a duration of service provided by the second ad hoc service provider, a location of the second ad hoc service provider, a price of service provided by the second ad hoc service provider, a quality metric of the second ad hoc service provider, and a quality of service provided by the second ad hoc service provider.

44. The machine-readable medium of claim 40, wherein the service information comprises one or more of the following: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider.

45. The machine-readable medium of claim 40, wherein the instructions further comprise code for:
receiving second information, third information, or both the second and third information from the server, the second information based on the information regarding the second ad hoc service provider, the third information comprising information regarding a third ad hoc service provider;
supporting transmission of the second information, the third information, or both the second and third information to a mobile client.

46. The machine-readable medium of claim 45, wherein the second information comprises an identifier of the second ad hoc service provider and further comprises one or more of the following service information: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider, and
wherein the third information comprises an identifier of the third ad hoc service provider, and further comprises one or more of the following service information: channel information of the third ad hoc service provider, communication capacity of the third ad hoc service provider, a duration of service provided by the third ad hoc service provider, a location of the third ad hoc service provider, a price of service provided by the third ad hoc service provider, a quality metric of the third ad hoc service provider, and a quality of service provided by the third ad hoc service provider.

47. The machine-readable medium of claim 46, wherein the communication capacity of the second ad hoc service provider comprises dynamic information about available capacity and utilized capacity at the second ad hoc service provider, wherein the price of service provided by the second ad hoc service provider comprises dynamic pricing based on demand, wherein the communication capacity of the third ad hoc service provider comprises dynamic information about available capacity and utilized capacity at the third ad hoc service provider, and wherein the price of service provided by the third ad hoc service provider comprises dynamic pricing based on demand.

48. The machine-readable medium of claim 40, wherein the first mobile node is registered with the server, the second ad hoc service provider is registered with the server, and the mobile client is registered with the server.

49. The machine-readable medium of claim 40, wherein the instructions further comprise code for storing the information in the first mobile node, and
wherein the information is emitted by the second ad hoc service provider.

50. The machine-readable medium of claim 40, wherein the code for receiving comprises code for supporting reception of the information wirelessly from the second ad hoc service provider or supporting reception of the information wirelessly from a mobile client of the first mobile node after the mobile client of the fist mobile node receives the information wirelessly from the second ad hoc service provider.

51. The machine-readable medium of claim 40, wherein at least one of the first mobile node and the second ad hoc service provider comprises a position determining unit, and wherein the first mobile node is configured to support an access point to the network for a mobile client.

52. The machine-readable medium of claim 40, wherein the first mobile node is an ad hoc service provider comprising a user interface and a processing system, and wherein the processing system is configured to enable a user to access the network through the user interface.

53. The machine-readable medium of claim 40, wherein the first mobile node is an ad hoc service provider configured to support an access point by bridging a first wireless link with a mobile client to a second wireless link with the network, wherein the first wireless link uses a first wireless access protocol, and wherein the second wireless link uses a second wireless access protocol different from the first wireless access protocol.

54. A processing system configured to perform a method of acquiring or distributing information related to one or more alternate ad hoc service providers, the method comprising:
receiving at an ad hoc service provider information regarding a second ad hoc service provider, the ad hoc service provider configured to support an access point to a network for a mobile client, the information comprising service information of the second ad hoc service provider; and
transmitting the information to a server in the network.

55. The processing system of claim 54, wherein the information comprises beacon information broadcasted by the second ad hoc service provider, and wherein the step of receiving comprises monitoring the beacon information.

56. The processing system of claim 54, wherein the service information comprises service attributes of access to the network offered by the second ad hoc service provider.

57. The processing system of claim 54, wherein the service information comprises one or more of the following: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider.

58. The processing system of claim 54, wherein the method further comprises:
receiving at the ad hoc service provider second information, third information, or both the second and third information from the server, the second information based on the information regarding the second ad hoc service provider, the third information comprising information regarding a third ad hoc service provider; and
transmitting to the mobile client the second information, the third information, or both the second and third information.

59. The processing system of claim 58, wherein the second information comprises an identifier of the second ad hoc service provider and further comprises one or more of the following service information: channel information of the second ad hoc service provider, communication capacity of the second ad hoc service provider, a duration of service provided by the second ad hoc service provider, a location of the second ad hoc service provider, a price of service provided by the second ad hoc service provider, a quality metric of the second ad hoc service provider, and a quality of service provided by the second ad hoc service provider, and
wherein the third information comprises an identifier of the third ad hoc service provider, and further comprises one or more of the following service information: channel information of the third ad hoc service provider, communication capacity of the third ad hoc service provider, a duration of service provided by the third ad hoc service provider, a location of the third ad hoc service provider, a price of service provided by the third ad hoc service provider, a quality metric of the third ad hoc service provider, and a quality of service provided by the third ad hoc service provider.

60. The processing system of claim 54, wherein the method further comprises:
requesting registration of the ad hoc service provider with the server prior to the step of receiving, wherein the second ad hoc service provider is registered with the server, and the mobile client is registered with the server.

61. The processing system of claim 54, wherein the method further comprises storing the information at the ad hoc service provider,
wherein the information is emitted by the second ad hoc service provider.

62. The processing system of claim 54, wherein the step of receiving comprises receiving the information wirelessly from the second ad hoc service provider or receiving the information wirelessly from the mobile client after the mobile client receives the information wirelessly from the second ad hoc service provider.

63. The processing system of claim 54, wherein at least one of the ad hoc service provider, the second ad hoc service provider, and the mobile client comprises a position determining unit, and wherein the second ad hoc service provider is configured to support an access point to the network for a mobile client.

64. The processing system of claim 54, wherein the ad hoc service provider comprises a user interface, and the method further comprises enabling a user to access the network through the user interface.

65. The processing system of claim 54, wherein the ad hoc service provider is further configured to support the access point by bridging a first wireless link with the mobile client to a second wireless link with the network, wherein the first wireless link uses a first wireless access protocol, and wherein the second wireless link uses a second wireless access protocol different from the first wireless access protocol.
